(19) United States
(12) Patent Application Publication
(10) Pub. No.: US 2025/0261591 A1
(43) Pub. Date: Aug. 21, 2025

(54) HARVESTING APPARATUS INCLUDING A SHAKER HEAD AND BLOWER, AND RELATED METHODS

(71) Applicant: FLORY INDUSTRIES, Salida, CA (US)

(72) Inventors: Mike Flora, Modesto, CA (US); Seth Richmond, Visalia, CA (US); Robert James Bill, Marysville, CA (US)

(21) Appl. No.: 19/200,668

(22) Filed: May 7, 2025

Related U.S. Application Data
(63) Continuation-in-part of application No. 18/985,084, filed on Dec. 18, 2024.
Application No. 18/985,084 is a continuation of application No. 17/039,988, filed on Sep. 30, 2020, now Pat. No. 12,245,551.
Application No. 17/039,988 is a continuation of application No. 16/104,133, filed on Aug. 16, 2018, now Pat. No. 10,806,080.
(60) Provisional application No. 62/605,753, filed on Aug. 25, 2017.
(60) Provisional application No. 63/683,553, filed on Aug. 15, 2024.

(51) Int. Cl. A01D 46/26; A01D 46/20; A01D 51/00

(52) U.S. Cl. CPC A01D 46/26; A01D 46/20; A01D 51/002; A01D 2046/262

(57) ABSTRACT

A harvesting apparatus and method for efficient fruit and nut collection in orchards. The apparatus comprises a shaker head with three axes of motion for engaging and shaking tree trunks to dislodge produce, and a blower for clearing fallen fruit or nuts from beneath the trees to an adjacent path for easy collection. The apparatus operates by moving between rows of trees, shaking each tree, and blowing the fallen produce into the next path in a single pass of the apparatus down the orchard row. This method ensures thorough and efficient harvesting, reducing labor and increasing productivity. The invention is suitable for various tree sizes and orchard layouts, enhancing operational efficiency and simplifying the harvesting process.

### FIELD OF THE INVENTION

The present invention relates generally to harvesting apparatus having a shaker head and a blower, and related methods.

### BACKGROUND OF THE INVENTION

Efficient harvesting of tree crops is a significant challenge in modern agriculture, often requiring a multitude of specialized vehicles that perform individual functions. This fragmented approach involves separate machines for shaking trees, collecting fallen produce, and processing the harvest. Each step in the process consumes substantial man-hours and resources, leading to increased operational costs and inefficiencies.

For example, traditional blower devices are used in the harvesting process after the crop has been removed from the trees by a shaker. These blowers are equipped with discharge openings that direct airflow laterally, intended to clear the produce from beneath the trees. However, conventional blower equipment is often inadequate for clearing produce from directly beneath the trees or organizing produce for collection by a harvester. The result can be that a significant portion of the crop, approximately 10%, remains uncollected, necessitating additional passes and further manual intervention.

The inefficiency of existing equipment, such as separate tree shakers and blowers, underscores the need for an integrated solution that can streamline the harvesting process. A more comprehensive approach is required to minimize the number of vehicles and manual labor involved, ensuring a thorough and efficient collection of tree crops.

Therefore, there is a need for more efficient vehicles and methods to improve the harvesting process.

### SUMMARY OF THE INVENTION

The present invention provides a novel vehicle that includes multiple functionalities, including crop removal and windrowing.

The present invention provides a mobile harvesting vehicle, equipped with a shaker head and a blower. The harvesting vehicle is designed to shake the fruit or nuts from trees using the shaker head and then blow the fallen crop out from under the tree to an adjacent area using the blower, where it can be picked up by a harvester. The blower discharges a high-velocity flow of air laterally outwardly from the vehicle's path. In some embodiments, the direction of the air flow can be adjusted relative to the vehicle's direction of travel to allow adjustment of the air discharge path.

The main objective of this invention is to provide a harvesting vehicle that can move along one side of a row of trees, shake the nuts or fruits using the shaker head, and blow them from the ground under the trees to the adjacent area using the blower. The vehicle can shake and move the nuts or fruit out from under the trees in a single pass along the row of trees. A sweeping machine may then pass on the opposite side of the row to create windrows.

In one embodiment, the harvesting vehicle includes a shaker head mounted to a multi-jointed articulated arm that is operable to align with the trunk of a tree. The shaker head may include a clamping mechanism with opposed clamp arms and an eccentric or oscillating weight system to apply controlled vibrational forces to the trunk. The articulated shaker arm may include a proximal pivot joint and a distal pivot joint that allow for three-axis movement of the shaker head, including pivoting motion and vertical displacement. These joints may be actuated by servo motors or linear actuators controlled via a microcontroller located in the vehicle cab. The position and operation of the shaker head may be monitored and adjusted using optical sensors, including LiDAR and stereo cameras, which provide real-time environmental mapping to assist in aligning the shaker head with the tree trunk.

The shaker head may be operable in both manual and semi-automated modes. In manual mode, the operator uses cab-mounted electronic controls and a graphical user interface to maneuver the shaker arm and initiate the clamping and shaking sequences. In semi-automated embodiments, the microcontroller may process sensor input to determine the optimal alignment and shaking parameters, controlling motorized components accordingly. The shaking force, frequency, and duration may be actively regulated to prevent damage to the tree while ensuring effective fruit or nut removal.

The harvesting vehicle further includes a blower unit configured to direct high-velocity air beneath the tree canopy to clear fallen produce into an adjacent path for subsequent collection. The blower may be mounted on the vehicle frame. In other embodiments, the blower may be mounted to a trailer towed behind the shaker vehicle. In either case, the blower is mechanically coupled to structures that permit adjustment of both the pitch angle (tilt) and the yaw angle (side-to-side rotation) of the blower discharge outlet. These adjustments allow the discharge path to be tuned for orchard-specific conditions such as terrain slope, tree spacing, and crop density.

In certain embodiments, the blower unit is mounted on a support structure configured to provide multi-axis movement, enabling the discharge outlet of the blower to be adjusted in pitch, yaw, and lateral extension. The support structure may include a horizontal pivoting mount that defines a pitch axis, allowing the blower to tilt forward or backward relative to the ground surface. This pitch adjustment enables the discharge airflow to be directed at varying angles beneath the canopy of a tree, thereby accommodating variations in terrain, tree geometry, or desired discharge distance. A vertical pivoting mount, such as a rotational bearing or vertical axle, may also be provided to enable yaw adjustments, allowing the blower outlet to swing laterally forward or aft relative to the vehicle's travel path. Pitch angles may be varied from approximately 10° to 45° from horizontal, while yaw angles may be adjusted to redirect airflow laterally outward from the vehicle path. These pitch and yaw pivots may be provided in combination to facilitate compound angle control of the blower outlet.

To enable lateral extension and retraction of the blower unit relative to the main vehicle or trailer frame, the support structure may include a track-mounted carriage assembly. In some embodiments, the blower unit is mounted to a linear track or sliding rail system aligned transversely to the vehicle's direction of travel. The blower can thus be moved between a retracted position, for compact stowage or travel between rows, and an extended position, for reaching beneath tree branches or foliage on the opposite side of a tree trunk. This linear translation may be powered by electronic linear actuators, motor-driven lead screws, belt or chain drives, or hydraulic cylinders, each operable to extend or retract the blower under motorized control.

The pitch, yaw, and extension mechanisms are each actuated by respective electric motors, such as servo motors, stepper motors, or geared DC motors, which are electronically connected to a central controller. Each motor may include an integrated encoder or position sensor to enable closed-loop feedback control, ensuring precise positioning of the blower discharge outlet. These motors are controlled via an electronic control system that may use pulse-width modulation (PWM) or variable frequency drive (VFD) techniques to regulate motor speed and torque. In some embodiments, the motor drivers are directly managed by a microcontroller or embedded processor located in the harvesting vehicle's cab, which executes software algorithms for real-time blower orientation control.

In some embodiments, the harvesting vehicle further includes a rotating harvesting brush mounted to a lateral boom extending from the vehicle chassis. The brush is configured to sweep fruit or nuts dislodged by the shaker head laterally across the orchard row, toward the opposite side of the tree from the vehicle. The boom may include a telescoping section that allows the brush to extend outward to reach beneath tree canopies of varying widths. The brush is rotatably actuated by an electric or hydraulic motor and may operate in coordination with the blower to assist in clearing fallen produce from beneath the trees. The brush and telescoping mechanism may be electronically controlled by the vehicle's central controller, which receives operator input or sensor feedback to determine optimal brush deployment and operation during harvesting.

Control commands may be input by the operator using cab-mounted user interface elements such as joysticks, knobs, or touchscreen displays. In some implementations, the system may be semi- or fully autonomous, with the microcontroller processing sensor inputs (e.g., from LiDAR, infrared, or stereo cameras) to calculate optimal blower positioning. The system may implement a data fusion algorithm to determine the spatial location of fallen produce, the location of obstacles or foliage, and the terrain gradient. Based on this environmental model, the controller adjusts the blower orientation to maximize clearing efficiency. These adjustments can be made continuously in real time during harvesting operations, thereby enabling dynamic targeting of airflow and improving the effectiveness of crop relocation for collection.

Sensor systems, including LiDAR and infrared cameras, may be mounted on or near the blower unit and integrated into the central control system. These sensors may provide real-time environmental data regarding the presence and distribution of fallen produce, foliage density, and terrain characteristics. The microcontroller may execute data fusion algorithms to generate a 3D environmental map and automatically determine the optimal positioning and orientation of the blower. Based on this data, the controller issues real-time commands to the motorized mounts to reorient the blower discharge outlet, either under manual operator supervision or in an automated fashion.

By coordinating the articulated motion of the shaker assembly with the adjustable, sensor-guided operation of the blower unit, the invention enables efficient, high-precision harvesting of tree crops. This integration reduces missed fruit, minimizes ground clutter, and enables effective windrowing with minimal labor. The invention is adaptable to varying orchard geometries and supports both manual and automated modes of operation, thereby offering a flexible and scalable solution for modern agricultural harvesting.

Another objective is to construct a harvesting vehicle that can function as a self-propelled ground vehicle or be supported and propelled by supportive and draft units. In some embodiments, the invention may provide a harvesting system in which the blower unit is mounted on a trailer attached to the shaker vehicle. This trailer-mounted configuration enables flexible deployment of the blower independently of the main chassis, allowing for optimized positioning and enhanced adaptability to varied orchard terrains. The trailer may include an articulating mount that allows the blower discharge outlet to be adjusted both in pitch and yaw relative to the direction of travel. In certain embodiments, the trailer includes a vertical pivot mount and a horizontal pivot mount actuated by electric motors such as stepper or servo motors, enabling controlled adjustment of the discharge angle in both vertical and horizontal planes. The trailer may also include a sliding track assembly that allows for lateral translation of the blower along an axis perpendicular to the vehicle's path of movement, thereby improving the ability to target difficult-to-reach areas beneath tree canopies.

In embodiments using a trailer-mounted blower, the blower unit may be supported by a trailer frame that includes both vertical and horizontal pivoting mounts actuated by electric motors such as stepper motors or servo motors. A sliding track or telescoping extension system may also be provided to permit lateral translation of the blower relative to the trailer or vehicle axis, enhancing reach beneath trees. The trailer-based blower system may be electronically connected to the controller of the shaker vehicle via a wired or wireless interface, allowing unified control of shaker and blower operations. The blower unit may be electronically connected to the central controller of the shaker vehicle through a wired or wireless interface. These connections allow the controller to send real-time commands to the electric motors on the trailer for adjusting the blower's orientation and extension.

Yet another objective is to provide a blower with variable air discharge angles and sensors to detect objects and oscillate the air discharge path accordingly.

A final objective is to create a harvesting vehicle that is simple to manufacture, easy to use, economically feasible, durable, and relatively trouble-free in operation.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 is a posterior view of a harvesting vehicle according to an embodiment of the present invention.

FIG. 2 is a posterior view of a harvesting vehicle according to an embodiment of the present invention.

FIG. 3 is an overhead view of a harvesting vehicle according to an embodiment of the present invention.

FIG. 4 is an overhead view of a harvesting vehicle according to an embodiment of the present invention.

FIG. 5 is an overhead view of a harvesting vehicle according to an embodiment of the present invention.

FIG. 6 is an overhead view of a harvesting vehicle according to an embodiment of the present invention.

FIG. 7 is an overhead view of a harvesting vehicle according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

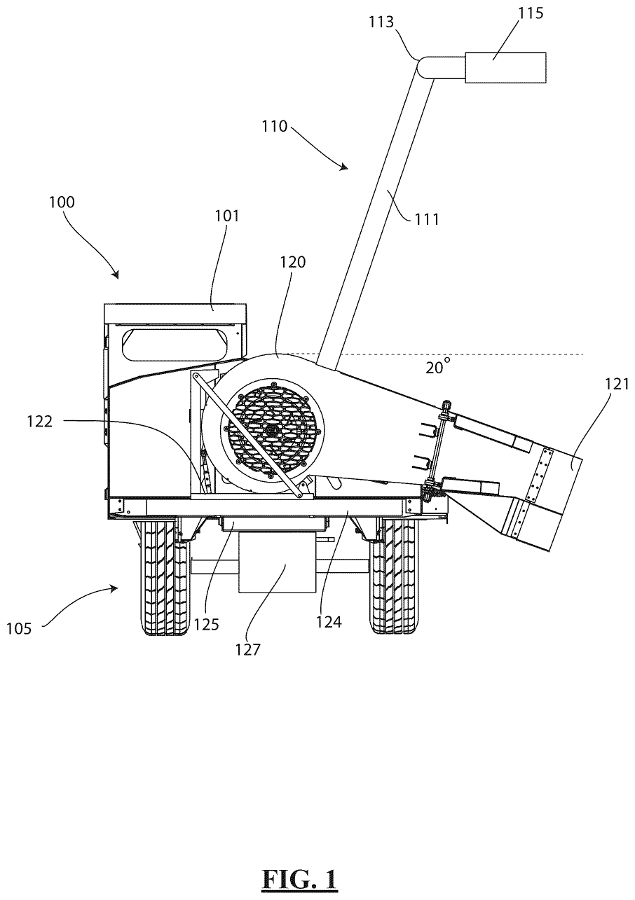

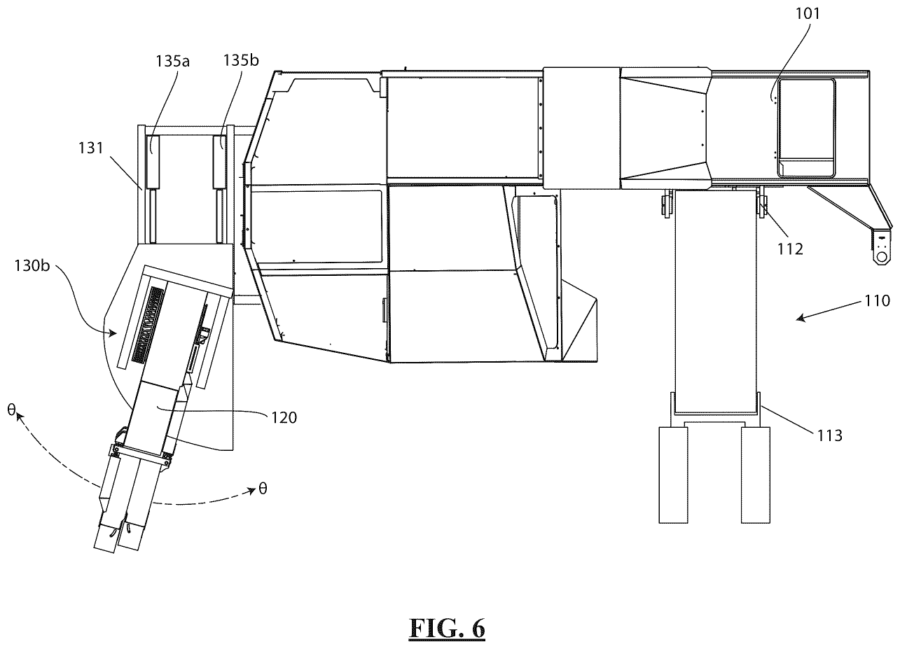

Referring to the drawings, wherein like reference characters designate like or corresponding parts throughout the several views, and referring particularly to FIGS. 1-6, it is seen that the present invention includes various embodiments of a harvesting vehicle 100 includes a self-propelling vehicle having a shaker head assembly 110 and a blower unit 120.

The shaker head assembly 110 of the harvesting vehicle 100 provides efficient removal of fruit or nuts from trees. The shaker head 110 may have a shaker head 115 that operates on three axes of motion, providing versatility and thoroughness in shaking various tree types and sizes. The shaker head 115 may be equipped with a weight system that can be configured as either one or more eccentric weights or an oscillating weight system. The eccentric weight system involves a rotating weight that generates centrifugal force, causing vibrations that shake the tree when the shaker head 115 is attached thereto. Alternatively, the shaker head 115 may include an oscillating weight system that uses, e.g., electromagnetic propulsion to move weights back and forth rapidly. This electromagnetic system offers precise control over the frequency and amplitude of the oscillations, allowing for gentle to vigorous shaking as required by different fruit or nut varieties.

In some embodiments, the shaker arm 111 may include multiple joints and motors that facilitate motion and alignment with a targeted tree or bush. The shaker arm 111 may feature a pivoting joint 112 at its proximal end, allowing the arm 111 to pivot relative to the vehicle body, a pivoting shaker head 115 capable of 180-degree pivoting movement relative to the shaker arm 111 at pivoting joint 112. The pivoting joint 112 at the proximal end of the shaker arm 111 may be controlled by a linear actuator driven by a servo motor, enabling smooth and controlled pivoting of the arm relative to the vehicle 100. At the arm's distal end, a pivoting joint 113 powered by a linear actuator allows the shaker head to pivot up to about 180 degrees, adapting to various trunk geometries and foliage profiles and allowing for a folded storage arrangement with the shaker arm 111 raised and the shaker head 115 folded downward.

The motion and clamping action of the shaker head 115 may be controlled by an operator in the cab 101 through electronic controls mounted in the interior of the cab 101. This manual intervention may be facilitated by optical sensors (e.g., cameras) mounted at or near the shaker head with the data transmitted to a display in the cab 101, where the display includes a graphical user interface operable to receive input from the operator. A microcontroller may be used to control the action of shaker arm 111 and shaker head 115 through instructions provided by the operator through manual controls in the cab 101. Once the vehicle 100 is in position, the shaker arm 111 may be lowered into position in alignment with the tree or bush. The operator may adjust the angle of the shaker head 115 via the linear actuator at the distal joint 113, aligning the shaker head 110 with the targeted portion of the trunk (e.g., a portion with sufficient thickness and no foliage) and then activate the clamp 116 to squeeze the trunk. The user may then activate the shaker mechanism through control commands transmitted through the microcontroller or by direct electrical signal, which first closes the clamp arms 116a and 116b on the targeted portion of the trunk. The shaker head 115 then applies the necessary force to dislodge the fruit or nuts while continuously monitoring sensor data to maintain optimal shaking force and prevent damage.

In some embodiments, the microcontroller may electronically interface with motors and sensors associated with the shaker arm 111 and shaker head 115 in an automated manner. The vehicle 100 may include optical sensors to monitor the position and alignment of the shaker arm 111 and shaker head 115 with the targeted tree or bush, providing real-time data to the microcontroller for precise control. LiDAR sensors 128, which use laser light to measure distances and create high-resolution 3D maps, communicate with the microcontroller via serial communication protocols such as UART or SPI, enabling efficient data transfer. Stereo cameras 129 may capture images from different angles to compute depth information and generate a 3D model of the tree trunk and foliage, communicating with the microcontroller through high-speed interfaces like USB, Ethernet, MIPI, 12C, SPI, Wi-Fi, UART, or Bluetooth.

Data from these optical sensors is continuously captured and transferred to the microcontroller, which may run data analysis algorithms to create an accurate three-dimensional model of the environment. For example, data analysis algorithms may include image processing, pattern recognition, depth estimation, and the like. The algorithms may process the raw optical data to extract relevant features such as edges, contours, or textures of the surrounding environment, thereby rendering an accurate 3D model.

The processed data and 3D model informs the microcontroller's control commands, adjusting the position, angle, and clamping action of the shaker head 115 to ensure correct alignment with the tree trunk and effective shaking force application. The microcontroller may also integrate data from optical sensors to monitor the position of the shaker arm 111 and shaker head 115, and the shape and characteristics of the tree or bush trunk in real-time. The control process may include the microcontroller initializing the system and calibrating the sensors and motors. The microcontroller may then process sensor data to determine the optimal positioning of the shaker arm 111 and send commands to a servo motor at the proximal joint 112 to pivot the arm towards the tree or bush.

The microcontroller may integrate data from LiDAR, stereo cameras, and infrared sensors, calculating the optimal position and angle for the shaker head 115. The central controller may be in electronic communication with the optical sensors and electrical motors, and may be programmed with electronic control algorithms to ensure accurate and secure operation. Commands are sent to the servo motors to adjust the position of the shaker head 115, and stepper motors operate the clamping mechanism based on the diameter and position of the trunk. Once the shaker head 115 is correctly positioned and clamped, the controller activates the shaking action using an appropriate motor system, regulated to apply the necessary force without damaging the tree. The motor system may be regulated using feedback mechanisms operable to apply a sufficient amount of force to dislodge the fruits or nuts. In such embodiments, the controller is operable to monitor the force exerted by the shaker, the frequency of the vibrations, and the response of the tree.

Once the arm is in position, the microcontroller may adjust the angle of the shaker head via the linear actuator at the distal joint 113 by aligning the shaker head 115 with the targeted portion of the trunk (e.g., a portion with sufficient thickness and no foliage). The microcontroller may then activate the shaker mechanism, which first moves the clamp arms until they are applying the necessary force to dislodge the fruit or nuts while continuously monitoring sensor data to maintain optimal shaking force and prevent damage. For storage, the microcontroller commands the actuators to retract the shaker arm and fold the shaker head downward, achieving a compact and secure configuration. This sophisticated system enables precise motion and alignment for efficient tree harvesting, ensuring smooth and effective operation throughout the process.

The microcontroller may continuously monitor the shaker head's position and trunk alignment through sensor feedback, making real-time adjustments to the position, angle, and clamping force as needed. The algorithm includes safety protocols to prevent excessive force or misalignment, protecting both the equipment and the trees. This integrated system of optical sensors, precise electrical motors, and advanced electronic control algorithms ensures that the shaker head connects to the tree trunk accurately and securely, enhancing the efficiency and effectiveness of the harvesting process while minimizing the risk of damage to the trees.

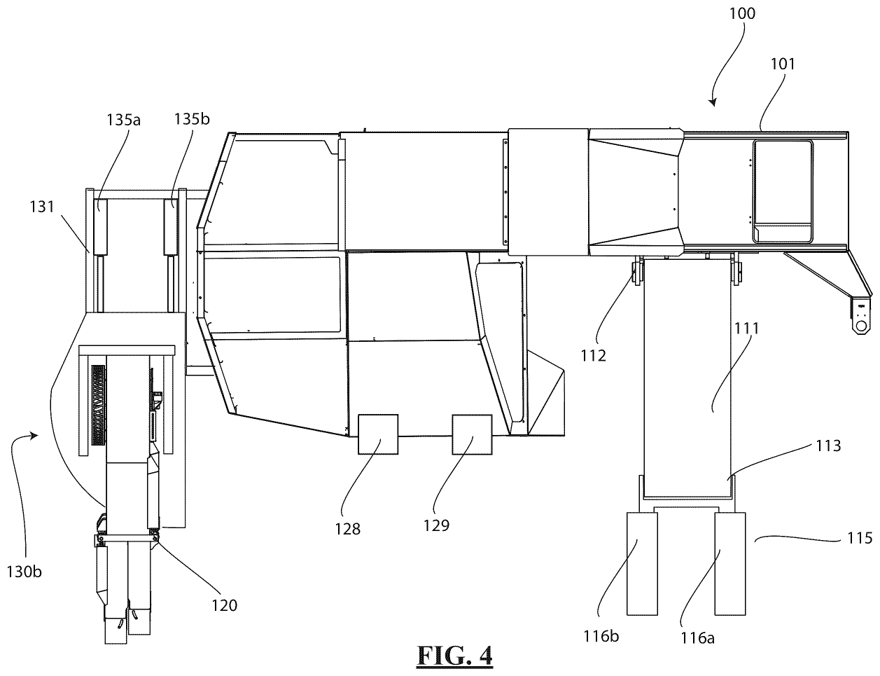

As shown in FIG. 4, in some embodiments, the shaker head 115 and shaker arm combination 111 may have three-axis motion allowing the shaker head 115 to move not only vertically and horizontally but also rotationally, ensuring access and effective engagement with tree trunks of any shape or angle.

The system employs servo motors, stepper motors, and linear actuators to control the movement of the shaker head 115. Servo motors offer precise angular position control, adjusting the angle and orientation of the shaker head 115. Stepper motors provide accurate, repeatable movements, managing the positioning and clamping mechanism. Linear actuators convert rotational motion into linear motion, controlling the clamping action of the shaker head to ensure a firm grip on the trunk.

In some embodiments, the blower unit 120 may be movably mounted on the vehicle 100 to allow for changes in the position and angle of the discharge outlet 121 of the blower unit 120. The blower unit 120 includes a centrifugal blower assembly supported from the frame. The blower unit 120 includes a discharge outlet 121 from which a jet discharge of air is directed during operation. The discharge outlet 121 may open laterally outwardly toward one side of the vehicle's path. The discharge outlet can be inclined forwardly and rearwardly relative to the vehicle's movement in its extreme positions of oscillation.

The blower unit 120 may be attached to the vehicle 100 by a mounting bracket 122 positioned on a deck 124 at the rear aspect 105 of the vehicle 100. The blower 120 may be mounted such that the discharge outlet 121 has a pitch angle in a range of about 10° to about 45° from the horizontal (e.g., about 15° to about 25° from the horizontal, about 20° from the horizontal, or any value or set of values therein). The discharge outlet 121 is positioned in order to maximize the movement of fruit, nuts, or other crops present on the ground beneath a crop row into the adjacent path between crop rows to facilitate a windrowing operation.

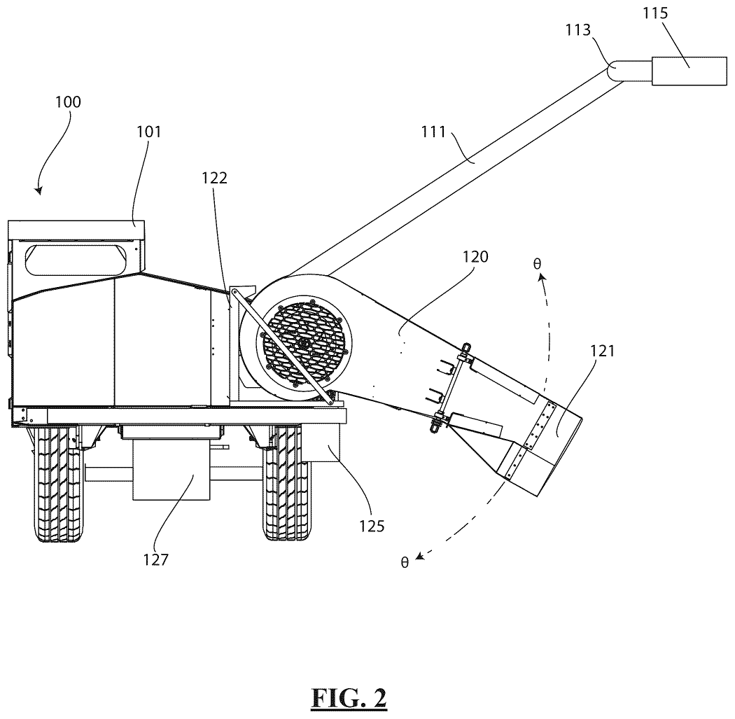

In some embodiments, the blower unit 120 may be attached to the vehicle 100 by a rotating mount having a pivoting horizontal axis that allows the pitch of the blower to be adjusted to between range of about 10° to about 45° from the horizontal, as shown in FIG. 2. The angle adjustment allows for accommodation of variations in orchard layouts in terms of tree spacing, terrain, and types of crops. An adjustable pitch angle enables the blower to be adapted to areas with closer tree spacing and less space in the paths between the tree or crop rows, and allows the angle to be optimized to move the crops to the desired distance in the adjacent path. The horizontal pivoting axis may be provided by a pivoting mount 122A on the mounting bracket 122. In some embodiments, an electric motor 126 (e.g., a stepper motor, a servo motor, a geared DC motor, or other motor that can be operated with electrical controls, electronic controls, and/or processor control) mechanically coupled to the pivoting mount 122A in order to allow the adjustment of the angle of the discharge outlet 121 without manual intervention.

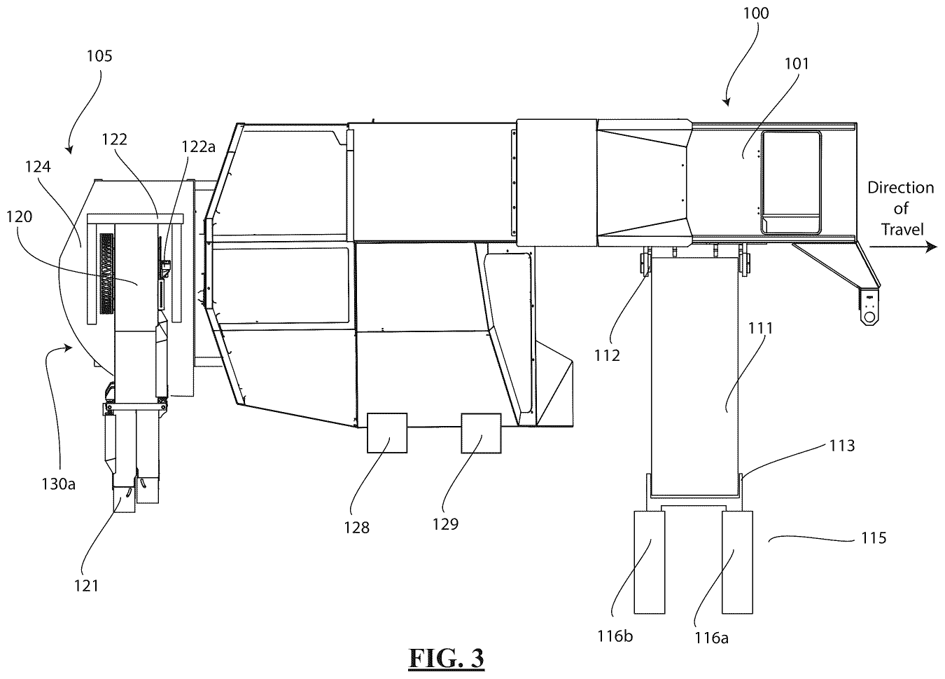

The position of the discharge outlet 121 may be perpendicular relative to the direction of travel of the vehicle 100, as shown in FIG. 3. This arrangement directs the flow of air from the discharge outlet 121 toward the crop row. In some embodiments, the mounting bracket 122 may be mounted on the deck 124 via a mount that allows for rotation around a vertical axis. The discharge outlet 121 is positioned in order to maximize the movement of fruit, nuts, or other crops present on the ground beneath a crop row into the adjacent path between crop rows to facilitate a windrowing operation.

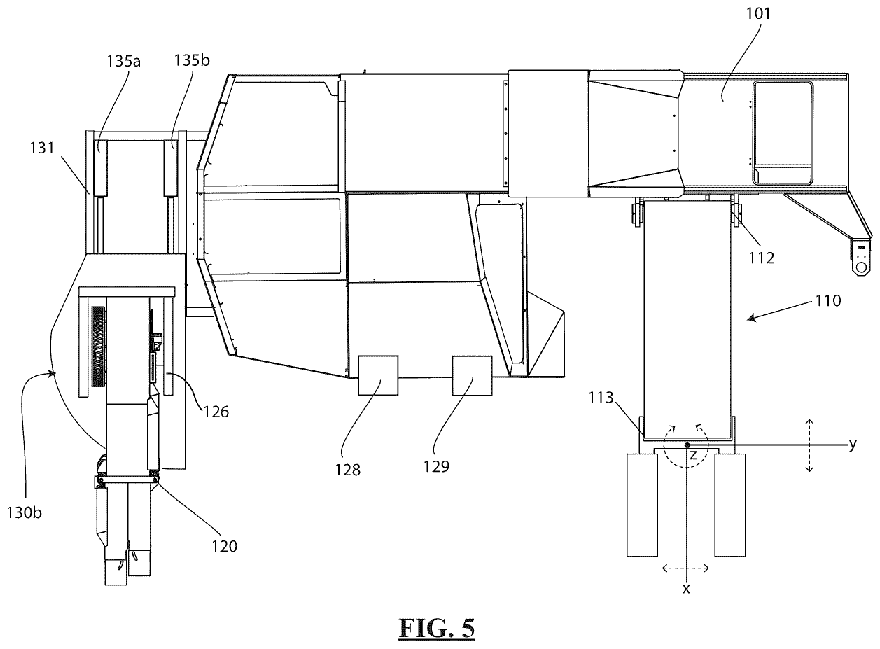

The blower unit 120 may be mounted on a pivoting vertical axis that allows the yaw angle of the blower discharge outlet 121 to be adjusted, as shown in FIG. 5. The yaw angle may be adjusted in a range of about 10° to about 45° around a vertical axis (e.g., about 15° to about 35° from the horizontal, or any value or set of values therein). The angle adjustment allows for precise directional control, enabling operators to direct the airflow to adapt to varying needs in different sections of the orchard, ensuring consistent movement of the produce to optimal locations for collection.

The horizontal pivoting axis may be provided by a mount pivoting device 125 in mechanical connection (e.g., a rotational axle) with mounting bracket 122. In some embodiments, an electric motor 127 (e.g., a stepper motor, a servo motor, a geared DC motor, or other motor that can be controlled with electrical controls, electronic controls, and/or processor control) may be mechanically coupled to mount pivoting device 125 in order to allow the adjustment of the yaw angle of the discharge outlet 121 without manual intervention.

The blower mount 124 may also be slidable from a retracted position 130a to an extended position 130b along a track 131, as shown in FIGS. 3-4. The motion along track 130 is perpendicular or substantially perpendicular to the direction of travel of the vehicle 100. The whole blower unit 120 mounted on bracket 122 may move along the track 130 and may be moved by electronic linear actuators 135a and 135b along track 130. Other mechanisms for moving the blower unit 120 along track 131 are contemplated in the scope of the present invention. For example, a chain-drive system may be used to move the blower unit 120 along track 131. In other examples, one or more hydraulic cylinders may be used to move blower unit 120 along track 131. The movement between the retracted and extended positions allows the blower discharge outlet 121 to be adjusted to reach into the tree line to access areas obstructed by foliage or crops that have fallen on the far side of the tree line.

The electrical motors connected to the pivoting mount 122A, the electronic linear actuators 135a and 135b, and the vertical rotation axle mount pivoting device 125 of the blower 120 can be managed using an electronic control system 150 that offers precise regulation of speed, direction, and torque. In some embodiments, the electronic control system may include the controller discussed herein that is operable to adjust the motor's speed by varying the frequency and voltage of its power supply. The microcontroller may in communication with a Variable Frequency Drive (VFD) including a rectifier, DC bus, and inverter, providing smooth control over a wide range of speeds with high efficiency. In other embodiments, the microcontroller may be in electronic communication with a Pulse Width Modulation (PWM) system, which regulates motor speed by adjusting the width of voltage pulses supplied to the motor. PWM controllers offer precise control over speed and torque with minimal power loss.

The microcontroller may manage the motor operation through software algorithms, interfacing with sensors and actuators to enable advanced functionalities like closed-loop control. This system ensures high precision and adaptability to varying conditions.

The operation of the electric motors 126 and 127 for adjusting the angle and position of the blower discharge outlet 121 may be controlled by an operator in the cab 101 through electronic controls mounted in the interior of the cab 101. This manual intervention may be facilitated by optical sensors (e.g., cameras) mounted at or near the blower unit 120 with the data transmitted to a display having a graphical user interface located in the cab 101. A microcontroller may be used to control the pitch angle and/or the yaw angle of the blower discharge outlet 121 through the electric motors 126 and 127 through instructions provided by the operator through manual controls in the cab 101.

In some embodiments, the control of the electrical motors 126 and 127 may be accomplished with an algorithm that processes data from the optical sensors (e.g., LiDAR sensors 128 and high-resolution cameras and infrared sensors 129) to manage the position and angle of the discharge outlet 121 for optimal fruit or nut collection. High-resolution 3D mapping of the orchard, capturing tree trunks, branches, and foliage positions may be used by the controller to detect and differentiate between foliage and fallen fruit on the ground. The sensors communicate with the central controller via sensor interface modules using digital communication protocols such as I2C, SPI, or CAN bus, providing reliable and fast data transfer for real-time processing.

In such embodiments, the controller may employ and interpret data fusion algorithms to combine inputs from the sensors. The LiDAR data may be processed to map tree trunks and foliage and image processing techniques may be used to locate fallen fruit, aided by infrared sensor data for distinguishing fruit from other debris. Based on this interpreted data, the controller may determine the best angles for the blower to clear the fruit effectively and may also determine the optimal path for the vehicle. In operation, the system continuously gathers data, processes it in real-time, and adjusts the position and angle of the blower 120 to optimize the fruit or nut collection process. This integrated approach ensures efficient operation of the harvesting vehicle, reduces manual intervention, and enhances overall orchard productivity.

The controller may send precise commands to the electric motors, adjusting the yaw angle of the blower by signal to motor 126 and the pitch angle by signal to motor 127 to direct air most effectively towards moving fruit to the collection path. The controller may also control motor speed and torque to match task requirements, ensuring efficient blower operation. PWM signals may be used for motor speed and direction control, with motor driver circuits amplifying these signals.

The harvesting vehicle 100 is an innovative agricultural machine designed to efficiently harvest fruit or nuts from trees in an orchard. This vehicle combines a shaker head assembly 110 and a blower 120, allowing it to both shake the produce from the trees and clear it from beneath the trees for easy collection. The harvesting process involves advancing the vehicle to a row of trees in the orchard, aligning the shaker head 110 with the first tree trunk. The vehicle's sensor system, if equipped, can assist in precise alignment to ensure optimal engagement with the tree.

In operation, as the harvesting vehicle 100 moves from tree to tree along a row of trees, the operator monitors the vehicle's progress and uses the cab-mounted controls to fine-tune its alignment with each tree. Once the vehicle 100 is properly aligned with a tree in the row, the operator may position the shaker head on the tree trunk using the manual controls in the cab 101. The shaker head 115 may be maneuvered to position itself around the tree trunk. This motion includes vertical, horizontal, and, in some embodiments, rotational adjustments to accommodate trees of various sizes and shapes. The operator or controller may utilize data from onboard sensors to assist in positioning the shaker head 115 accurately around the tree trunk, ensuring proper alignment for optimal shaking. Once the arms 116a and 116b of the shaker head 115 are positioned around the tree trunk, the operator can instruct the system to close clamp arms 116a and 116b of the shaker head 115 on the tree trunk. The clamp mechanism may be adjusted automatically by the system based on real-time sensor feedback to ensure a secure grip on the trunk. The operator may then activate the weight system of the shaker head 115 to transmit energy to the tree trunk to remove fruit or nuts from the tree. The shaker head can be equipped with either an eccentric weight system or an oscillating weight system powered by electromagnetic propulsion, which generates vibrations necessary to dislodge the fruit or nuts from the tree. The shaker head 115 is activated to shake the tree vigorously. The weight system generates strong, consistent vibrations. These vibrations effectively detach the fruit or nuts from the tree branches, causing them to fall to the ground beneath the tree. During this process, the system continuously monitors the shaking force via sensors, adjusting the vibration parameters to prevent damage to the tree. In other implementations, the controller may have automated control of the shaker head assembly 110 operation through software algorithms, interfacing with sensors and actuators, as discussed herein.

The fruit or nuts shaken from the tree can be moved from below the tree during and/or after the shaking process by operation of the blower unit 120, which may be operated simultaneously with the shaker assembly 110. The blower unit 120 is designed to clear the fallen produce from beneath the tree and move it into the adjacent path between rows of trees. The electronic motors and actuators allow the operator or controller to adjust the pitch and yaw angles of the blower's discharge outlet 121, optimizing the direction of the air flow to target specific areas beneath the tree. The blower 120 discharges a high-velocity flow of air, which can be directed and adjusted to ensure thorough clearing of the ground. The adjustable discharge path can be angled forwardly and rearwardly relative to the vehicle's movement, allowing for precise control over where the produce is blown. The operator or controller can also use linear actuators to move the blower between retracted and extended positions, enabling the blower to reach farther beneath the tree canopy or retract for safer navigation between trees.

Once the ground beneath the first tree is cleared, the operator moves the harvesting vehicle 100 to the next tree in the row. During this movement, sensors on the vehicle may assist the operator or automatically guide the vehicle to properly align with the next tree trunk, ensuring consistent engagement of the shaker head 115. In some implementations, a sensor system assists the operator in re-aligning the vehicle with the next tree trunk, repeating the process of engaging the shaker head 115, shaking the tree, and using the blower to clear the fallen crop. This systematic approach ensures that each tree in the row is thoroughly harvested. The sensors may provide real-time feedback to the operator, thereby displaying alignment information on the display, or through direct interfacing with the vehicle steering or propulsion system.

The produce that has been blown into the adjacent path may be collected using a separate harvester passing over the paths between the tree rows. This harvester can be operated independently or as part of a coordinated harvesting operation. The collection process is streamlined by the efficient clearing provided by the blower 120, reducing the time and labor required to gather the fruit or nuts from the orchard.

The harvesting vehicle 100 is designed to maximize operational efficiency and minimize downtime. Its robust construction, combined with the versatility of the shaker head assembly 110 and blower 120, allows for continuous operation in various orchard conditions. Using the harvesting vehicle 100 involves a well-coordinated process of aligning, shaking, and blowing to efficiently harvest fruit or nuts from trees. The inclusion of advanced sensor systems and electronic controls for motorized adjustments of the blower and shaker head ensures precision and adaptability in diverse orchard environments. The innovative design of the shaker head 110 and blower 120, along with the vehicle's ability to handle different tree sizes and orchard layouts, makes it a valuable asset for modern agricultural operations. This method not only increases the efficiency of the harvesting process but also reduces the labor required, making it an essential tool for orchard management.

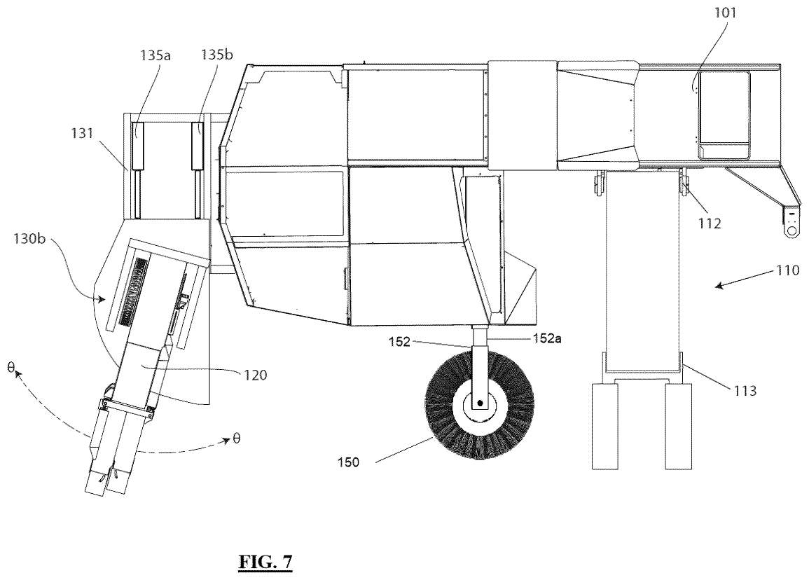

In a further embodiment of the harvesting vehicle 100, shown in FIG. 7, the apparatus includes a rotating harvesting brush 150 configured to sweep fruit or nuts shaken from the tree toward the opposite side of the orchard row from the vehicle. The harvesting brush 150 is positioned forward of the blower unit 120 relative to the direction of vehicle movement and is operable to contact the ground beneath the tree canopy.

The harvesting brush 150 is mounted to a lateral boom 152 extending from the side of the vehicle chassis. In some implementations, the boom 152 is configured with a telescoping section 152a that allows the brush 150 to be extended laterally outward from the vehicle to reach further beneath the canopy of a tree. The telescoping functionality enables the apparatus to adjust to variations in tree size and canopy density, ensuring effective sweeping even in dense or uneven orchard layouts.

The brush 150 is rotatably mounted on the distal end of boom 152 and includes bristles or flexible fingers configured to engage the ground and propel fallen produce laterally away from the vehicle and toward the opposite side of the orchard row, facilitating windrowing in coordination with the airflow from the blower unit 120.

The brush 150 may be actuated by an electric motor, such as a brushless DC motor or a geared DC motor, capable of providing the necessary torque and rotational speed for effective sweeping action across varying terrain. The motor may be mounted adjacent to or integrated within the brush hub assembly to minimize mechanical losses and reduce the overall profile of the rotating mechanism. In other embodiments, a hydraulic motor may be used, supplied by the vehicle's onboard hydraulic system.

The telescoping function of boom 152a may be powered by a linear actuator, which may be an electric screw-drive actuator, a chain-driven extension mechanism, or a hydraulic cylinder. This actuator enables the controlled extension and retraction of the boom, allowing the operator or the automated control system to dynamically adjust the lateral position of the brush during harvesting operations.

Both the brush motor and the telescoping actuator are in electronic communication with the central controller of the harvesting vehicle 100. The controller may be configured to manage the rotation speed and direction of the brush 150, as well as the extension or retraction of the boom 152a, based on operator input or automated control algorithms. The controller may receive sensor data from onboard systems such as LiDAR, cameras, or infrared sensors to determine the location of fallen produce and calculate optimal brush positioning.

Operator input may be provided via a graphical user interface within the cab 101, such as a touchscreen or joystick control. In autonomous or semi-autonomous modes, the controller may execute a harvesting algorithm that synchronizes the operation of the brush with the shaker head 115 and blower unit 120 to optimize clearing efficiency. For example, upon detecting dense clusters of fallen produce beneath the centerline of the tree, the controller may extend the boom 152a and activate the brush 150 to sweep the produce laterally outward in advance of the blower operation.

The brush 150 may also include an optional vertical adjustment mechanism, allowing the height of the brush relative to the ground to be tuned based on terrain slope or produce depth. This adjustment may be motorized and similarly controlled by the central controller.

This embodiment enhances the versatility of the harvesting vehicle by adding a mechanical sweeping component that can function either independently or in conjunction with the blower, thereby increasing the overall fruit or nut recovery rate, particularly in scenarios where blower-only systems may be insufficient to dislodge produce from dense foliage or uneven terrain.

The principles of the invention are illustrative, and numerous modifications and changes will readily occur to those skilled in the art. Therefore, it is not desired to limit the invention to the exact construction and operation shown and described. All suitable modifications and equivalents may be resorted to within the invention's scope.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A harvesting apparatus, comprising:
a. a vehicle chassis;
b. a shaker assembly mounted to the chassis and configured to engage a trunk of a tree in an orchard row and apply vibratory forces to remove fruit or nuts from the tree; and
c. a blower assembly mounted to the vehicle and configured to direct a flow of air beneath the tree to move the removed fruit or nuts to an opposite side of said orchard row for windrowing.

2. The harvesting apparatus of claim 1, wherein the shaker assembly includes a shaker arm with at least two pivot joints allowing multi-axis articulation of a shaker head, wherein the shaker arm is operable by at least one electric motor or linear actuator under control of an electronic controller.

3. (canceled)

4. The harvesting apparatus of claim 1, wherein the shaker assembly includes a clamping mechanism configured to secure the shaker head to the trunk of the tree during operation.

5. The harvesting apparatus of claim 1, wherein the blower assembly includes a discharge outlet that is adjustable in pitch and yaw relative to the chassis.

6. The harvesting apparatus of claim 5, wherein the discharge outlet is mounted to a pivoting support actuated by one or more electric motors.

7. The harvesting apparatus of claim 1, wherein the blower assembly is movably mounted to the chassis on a lateral track for extension and retraction relative to the vehicle's side.

8. The harvesting apparatus of claim 1, further comprising a microcontroller operable to control the operation of the shaker assembly and the blower assembly, and a blower control driver operable to apply an oscillation movement to the blower assembly.

9. The harvesting apparatus of claim 8, further comprising one or more optical sensors in communication with the microcontroller and configured to detect the position of a tree trunk or fallen fruit or nuts.

10. (canceled)

11. The apparatus of claim 8, further comprising a brush operable to sweep said fruit or nuts shaken from said tree toward said opposite side of said orchard row.

12. A harvesting apparatus, comprising:
a. a chassis;
b. a shaker head configured to engage a trunk of a tree in an orchard row and apply vibratory motion thereto to dislodge fruit or nuts; and
c. a blower unit configured to blow the dislodged fruit or nuts to a path opposite the tree trunk, wherein the shaker head and blower unit are operable to perform shaking and blowing operations sequentially or simultaneously in a single pass of said harvesting apparatus along said orchard row.

13. The harvesting apparatus of claim 12, wherein the shaker head is mounted to an articulated arm having a proximal pivot joint and a distal pivot joint for three-axis movement.

14. (canceled)

15. The harvesting apparatus of claim 12, wherein the blower unit includes a discharge nozzle having an adjustable pitch angle and yaw angle.

16. The harvesting apparatus of claim 15, wherein the blower unit includes one or more electric motors to control the pitch and yaw of the discharge nozzle, wherein the blower unit is mounted on a track system that allows lateral displacement of the blower relative to the chassis.

17. (canceled)

18. (canceled)

19. The harvesting apparatus of claim 18, wherein the apparatus includes a sensor system configured to provide feedback to a microcontroller for adjusting the position or angle of the shaker head or blower unit.

20. (canceled)

21. The harvesting apparatus of claim 12, wherein the path of the blower's air discharge is adjustable forwardly and rearwardly relative to the direction of movement of the harvesting apparatus.

22. (canceled)

23. A method for harvesting fruit or nuts in an orchard using a mobile harvesting apparatus, comprising:
a. positioning the apparatus adjacent to a tree in an orchard row;
b. engaging a shaker head with a trunk of the tree and applying a vibratory force to dislodge fruit or nuts; and
c. operating a blower attached to the apparatus to direct a stream of air beneath the tree and move the dislodged fruit or nuts to an opposite side of the orchard row for windrowing.

24. The method of claim 23, further comprising articulating the shaker head into position using an arm having multiple joints, wherein articulating the shaker head includes controlling one or more motors or actuators via an onboard controller and clamping the shaker head to the tree trunk before applying the vibratory force.

25. (canceled)

26. The method of claim 23, further comprising adjusting a pitch angle and/or yaw angle of a blower discharge outlet to direct airflow.

27. (canceled)

28. The method of claim 23, further comprising extending or retracting the blower relative to the vehicle using a lateral track mechanism.

29. (canceled)

30. (canceled)

31. (canceled)

32. (canceled)

33. (canceled)

34. The method of claim 23, further comprising operating a brush mounted to the apparatus to engage the ground and move the shaken fruit or nuts toward the opposite side of the orchard row, wherein the brush is positioned forward of the blower assembly and rotates in a direction that propels the fruit or nuts laterally toward the opposite side of the orchard row relative to the apparatus.

35. (canceled)

36. (canceled)

37-54. (canceled)
